(19) United States
(12) Patent Application Publication
(10) Pub. No.: US 2017/0270577 A1
(43) Pub. Date: Sep. 21, 2017

(54) CATALOGUE MANAGEMENT

(71) Applicant: eBay Inc., San Jose, CA (US)

(72) Inventors: Shifa Fazal Mahamood, San Jose, CA (US); Atiq Islam, San Jose, CA (US)

(21) Appl. No.: 15/070,760

(22) Filed: Mar. 15, 2016

(51) Int. Cl. G06Q 30/06

(52) U.S. Cl. CPC G06Q 30/0603; G06Q 30/0625

(57) ABSTRACT

A system and method of generating useful page names for product categories is disclosed. A system accesses a set of search terms associated with a particular product category. The system identifying product category names for the particular product category and one or more associated product categories. The system creates a plurality of potential product category names. For each potential product category name the system compares the potential product category name to the set of search terms associated with the particular product category. In accordance with a determination that the potential product category name matches any of the search terms, the system adds the potential product category name to a set of matching potential product category names. The system selects a product page name from the set of matching potential product category names and assigns the selected product page name to a webpage associated with the particular product category.

### TECHNICAL FIELD

Embodiments of the present disclosure relate generally to catalogue management and, more particularly, but not by way of limitation, to using user data to improve catalogue data.

### BACKGROUND

The rise in electronic and digital device technology has rapidly changed the way society interacts with media and the consumption of goods and services. Digital technology enables the convenient use of a variety of consumer devices that are very flexible in configuration and are relatively cheap. Specifically, modern electronic devices, such as smartphones and tablets, allow a user to have access to a variety of useful applications even when away from a traditional computer.

Online commerce is one particular area in which the rise of computer technology and the Internet has resulted in a new, dynamic marketplace. Internet-based commerce companies are able to present a much larger array of products and services for sale at any given moment. However, as the number of products rises, the difficulty in finding any particular product or product category also increases.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a client-server system environment that includes various functional components of a server system, in accordance with some example embodiments.

FIG. 2 is a block diagram further illustrating the client system, in accordance with some example embodiments.

FIG. 3 is a block diagram further illustrating the server system of FIG. 1, in accordance with some example embodiments.

FIG. 4 depicts a diagram of a category hierarchy tree for arranging each product category into a hierarchy in accordance with some example embodiments.

FIG. 5 illustrates a block diagram illustrating a system for generating useful page titles for static pages associated with particular product categories in accordance with some example embodiments.

FIG. 6 is a flow diagram illustrating a method, in accordance with some example embodiments, for fragmenting catalogue names to simple components that match vocabulary in which users express their intent.

FIGS. 7A-7B are a flow diagrams illustrating a method, in accordance with some example embodiments, for fragmenting catalogue names to simple components that match vocabulary in which users express their intent.

FIG. 8 is a block diagram illustrating an example of a software architecture that may be installed on a machine, according to some example embodiments.

FIG. 9 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative example embodiments of the disclosed subject matter. In the following description, for the purposes of explanation, numerous specific details are set forth in order to provide an understanding of various example embodiments of the disclosed subject matter. It will be evident, however, to those skilled in the art, that embodiments of the inventive subject matter may be practiced without these specific details. In general, well-known instruction instances, protocols, structures, and techniques are not necessarily shown in detail.

In some example embodiments, a network-based commerce service (e.g., a web-based store) has the potential to store data for a large number of products and services. For example, some network-based commerce services include data for millions of products and services. One way to manage data for such a large number of products is to organize the products into categories.

In some example embodiments, the product categories are then organized into a hierarchy (e.g., a map or tree), such that more general categories include more specific categories. Each node in the tree or map is a product category that has a parent category (e.g., a more general category with which the product category is associated) and potentially one or more child categories (e.g., narrow or more specific categories associated with the product category.). Each product category is associated with a particular static webpage. While some product pages are generated dynamically in response to user requests and so on, a static webpage is useful because it can be indexed and bookmarked and remains relatively unchanged over time.

However, each static webpage needs a title or heading with which it is identified. The names of product categories in the hierarchy can be too technical, specific, or otherwise difficult for a user to understand. As such, a useful title is determined for each static product page. Manually choosing this title would be far too expensive both in terms of the amount of money it would take to pay workers to analyze each category and in terms of the total amount of time such a process would take.

To automatically select the name of a particular product category's static page, a server system first determines a set of search terms that have resulted in a user clicking on the particular product category's static page. For example, each time a user submits a search query, the search query is recorded and a set of search results is generated. The search results are presented to the user and the user can select (by clicking) on one or more of the search results. When a user clicks on a particular product category's static page, the originating search query is recorded and is retrieved when the server system determines a set of search terms for that particular product page.

In some example embodiments, the set of search terms is reduced to only include the most common search terms. For example, the server system selects a predetermined number of the most common search terms. In other example embodiments, the server system selects a certain percentage of the top search results. Using this technique the long tail of search terms is reduced or eliminated.

The server system generates a set of words from the product category name and the name of all parent categories all the way up to the root node. For example, if the specific product category is men's tennis shoes, the set of words would also include the name of the parent category (men's athletic shoes) and its parent category (“men's shoes”) and so on.

The server system generates a set of potential product page names by generating different combinations of the set of words. Each potential product page name is then matched with the set of user search terms. The server system then identifies any potential product page names that match an identified search term.

For each matching potential product page name, the server system determines a score or rank that indicates the quality of the potential product name based on a variety of factors including the length of the name, the popularity of the matching search terms, and so on. The server system then selects the highest ranked potential product page name and assigns it to the product page associated with the particular product category.

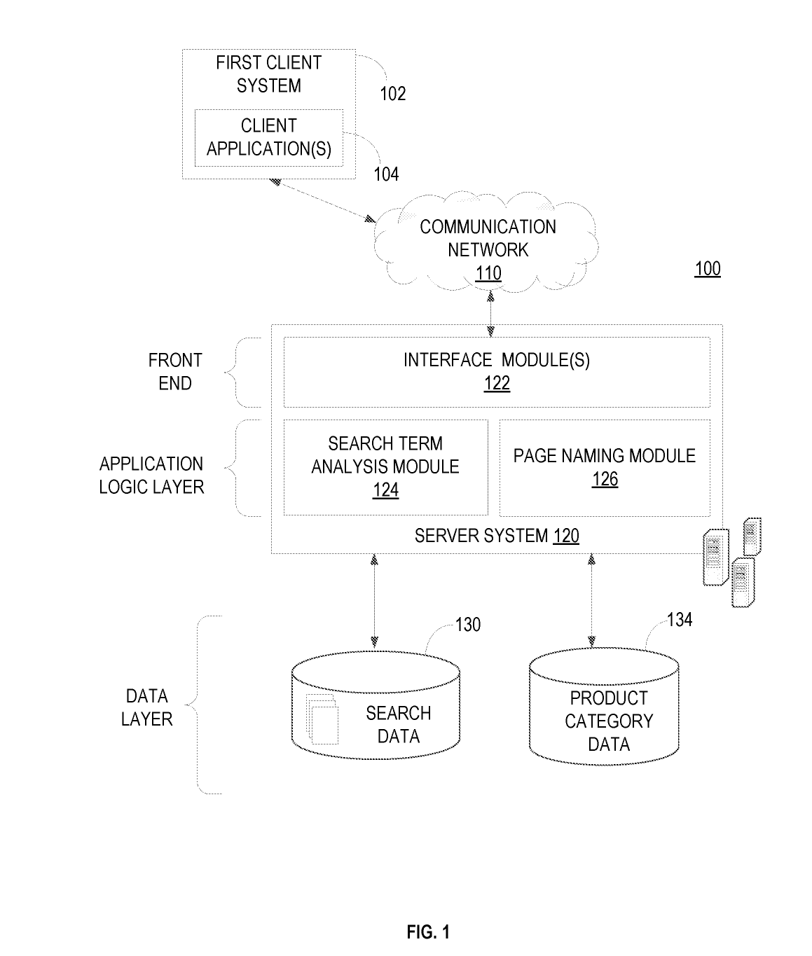

FIG. 1 is a network diagram depicting a client-server system environment 100 that includes various functional components of a server system 120, in accordance with some example embodiments. The client-server system environment 100 includes at least a client system 102 and a server system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses a web browser to send and receive requests to and from the server system 120 and displays information received from the server system 120.

In some example embodiments, the client system 102 includes an application specifically customized for communication with the server system 120 (e.g., an iPhone application). In some example embodiments, the server system 120 is a server system that is associated with one or more services.

In some example embodiments, the client system 102 sends a request to the server system 120 for a webpage associated with the server system 120. For example, a user uses a client system 102 to log into the server system 120 and clicks a link to view a job listing for a job they are interested in from server system 120. In response, the client system 102 receives the requested job listing data (e.g., data describing the position, the associated organization, the job requirements, and responsibilities) and displays that data in a user interface on the client system 102.

In some example embodiments, as shown in FIG. 1, the server system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a server system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various example embodiments are by no means limited to this architecture.

As shown in FIG. 1, the front end consists of an interface module(s) (e.g., a web server) 122, which receives searches from various client systems 102 and communicates the search results to the appropriate client system 102. In some example embodiments, the interface module(s) 122 implements a single application programmatic interface (API) which all client systems (102) use to send search queries and receive search results.

As shown in FIG. 1, the data layer includes several databases, including databases for storing various data for users of the server system 120, including search data 130 and product category data 134.

In some example embodiments, the search data 130 includes both data that is used to respond to user search queries (e.g., an index that is used to look up search results) and data that represents past search queries and any user interactions (e.g., user clicks) that resulted after the search results are displayed. Thus, the server system 120 can use the data stored about search results to identify which search terms result in clicks on particular pages.

In some example embodiments, the product category data 134 includes data describing a plurality of products. Each product is organized into a particular product category. Furthermore, each product category is organized as part of a hierarchy, such that each product category has a parent category (e.g., a more general category to which the product category belongs) and one or more child categories (e.g., more specific categories that are within the product category).

The server system 120 may provide a broad range of other applications and services that allow users the opportunity to buy and sell items, share and receive information, often customized to the interests of the user, and so on.

In some example embodiments, the application logic layer includes various application server modules, which, in conjunction with the interface module(s) 122, receive user search queries from a large variety of client systems (102) and stores the information in the search data 130.

A search term analysis module 124 and a page naming module 126 can also be included in the application logic layer. Of course, other applications or services that utilize the search term analysis module 124 and the page naming module 126 may be separately implemented in their own application server modules.

As illustrated in FIG. 1, with some example embodiments, the search term analysis module 124 and the page naming module 126 are implemented as services that operate in conjunction with various application server modules. For instance, any number of individual application server modules can invoke the functionality of the search term analysis module 124 and the page naming module 126. However, with various alternative example embodiments, the search term analysis module 124 and the page naming module 126 may be implemented as their own application server modules such that they operate as stand-alone applications.

Generally, the search term analysis module 124 receives a request to determine a set of search terms that are associated with a particular product page. The search term analysis module 124 then accesses the search data 130 to identify each search query that results in a user clicking on the particular product web page. The search term analysis module 124 then filters the resulting search terms to identify the most frequent search terms. For example, the search term analysis module 124 determines on average, for 100 clicks, which search terms result in the top 60 clicks. In this way, only the most applicable search terms will remain in the search term set.

In some example embodiments, the page naming module 126 generates a series of potential page names for a particular product category. In some example embodiments, the potential page names are created by creating different combinations of words that are included in both the name of the particular product category and all the parent categories. The page naming module 126 then compares each of the potential page names against the set of search terms generated by the search term analysis module 124.

Once a set of potential page names that match search terms has been generated, the page naming module 126 ranks the potential page names based on one or more factors. The top ranking potential page name is then selected as the static page name for that product category. In other example embodiments, the user interaction record already includes all the relevant user information. The search term analysis module 124 records the time and source of the user interaction record (if not already included in the record) and passes the user interaction record to the page naming module 126.

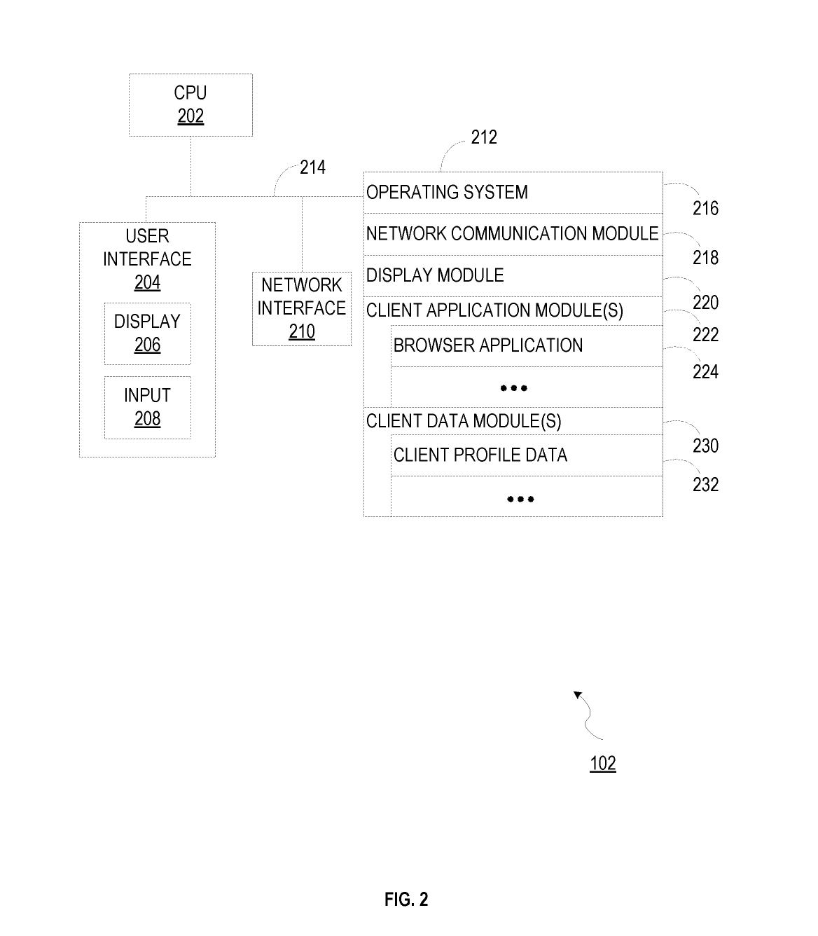

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input device 208 such as a keyboard, mouse, touch sensitive display, or other input means. Furthermore, some client systems use a microphone and voice recognition to supplement or replace other input devices.

The memory 212 includes high-speed random access memory, such as dynamic random-access memory (DRAM), static random access memory (SRAM), double data rate random access memory (DDR RAM) or other random access solid state memory devices, and may include non-volatile memory, such as one or more magnetic disk storage devices, optical disk storage devices, flash memory devices, or other non-volatile solid state storage devices. The memory 212 may optionally include one or more storage devices remotely located from the CPU(s) 202. The memory 212, or alternatively, the non-volatile memory device(s) within the memory 212, comprise(s) a non-transitory computer-readable storage medium.

In some example embodiments, the memory 212, or the computer-readable storage medium of the memory 212, stores the following programs, modules, and data structures, or a subset thereof:
an operating system 216 that includes procedures for handling various basic system services and for performing hardware-dependent tasks;
a network communication module 218 that is used for coupling the client system 102 to other computers via the one or more network interfaces 210 (wired or wireless) and one or more communication networks 110, such as the Internet, other WANs, LANs, MANs, etc.;
a display module 220 for enabling the information generated by the operating system 216 and the client application(s) 104 to be presented visually on the display device 206;
one or more client application modules 222 for handling various aspects of interacting with the server system 120 (FIG. 1), including but not limited to:
   a browser application 224 for requesting information from a web service associated with the server system 120 (e.g., content items and listings) and receiving responses from the web service associated with the server system 120; and
client data module(s) 230 for storing data relevant to the clients, including but not limited to:
   client profile data 232 for storing profile data related to a user of the server system 120 associated with the client system 102.

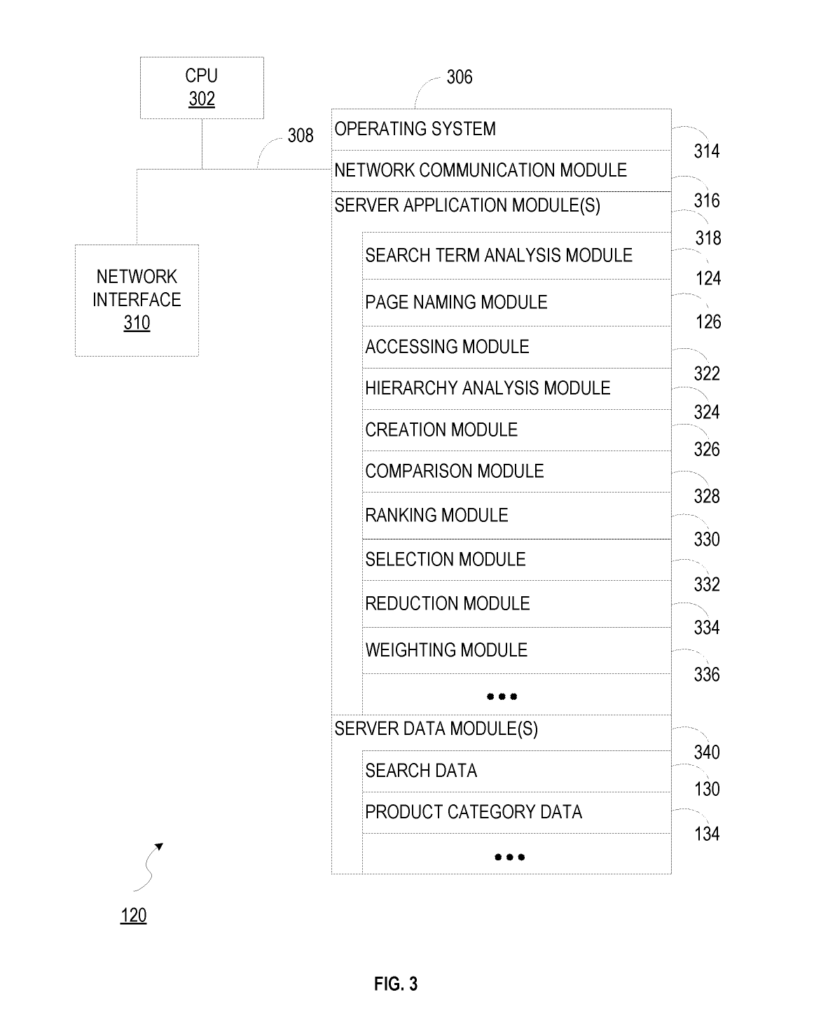

FIG. 3 is a block diagram further illustrating the server system 120, in accordance with some example embodiments. The server system 120 typically includes one or more CPUs 302, one or more network interfaces 310, memory 306, and one or more communication buses 308 for interconnecting these components. The memory 306 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 306 may optionally include one or more storage devices remotely located from the CPU(s) 302.

The memory 306, or alternately the non-volatile memory device(s) within the memory 306, comprises a non-transitory computer-readable storage medium. In some example embodiments, the memory 306, or the computer-readable storage medium of the memory 306, stores the following programs, modules, and data structures, or a subset thereof:
an operating system 314 that includes procedures for handling various basic system services and for performing hardware-dependent tasks;
a network communication module 316 that is used for coupling the server system 120 to other computers via the one or more network interfaces 310 (wired or wireless) and one or more communication networks 110, such as the Internet, other WANs, LANs, MANs, and so on;
one or more server application modules 318 configured to perform the services offered by the server system 120, including but not limited to:
   a search term analysis module 124 for receiving search queries and a request for a set of search terms associated with a particular product category based on stored search data 130 and product category data 134;
   a page naming module 126 for selecting a name for a webpage associated with a particular product category based on words associated with the product category and its parent categories and the search terms associated with selecting the static product page associated with the product category;
   an accessing module 322 for accessing search data 130 and the product category data 134 from a database associated at the server system 120;
   a hierarchy analysis module 324 for determining, given a particular product category, all the parent and child product categories for that particular product category (i.e., more general and specific categories respectively);
   a creation module 326 for creating one or more potential product page names for a particular product category based on combinations of words from the particular product category and all of its parent product categories;
   a comparison module 328 for comparing the one or more potential product names with the set of search terms that are associated with the particular product category to find potential product names that match a search term;
   a ranking module 330 for ranking each matching potential product name based on the degree to which the potential product name matches one or more relevance criteria;
   a selection module 332 for selecting a particular potential product name based on the relative rankings of each potential product name that matches one of the search terms;
   a reduction module 334 for removing less frequent search terms from the set of all search terms associated with a particular product category; and
   a weighting module 336 for determining which factors are the most important for ranking potential page names; and
server data module(s) 340, storing data related to the server system 120, including but not limited to:
   search data 130, including both data used to respond to search queries (e.g., data that indexes the products and can respond to searches) and data describing past search queries and what the users clicked on in response to display of the search results; and
   product category data 134 for storing the hierarchy of product categories, including which products are in which product categories and the relationship between the various product categories.

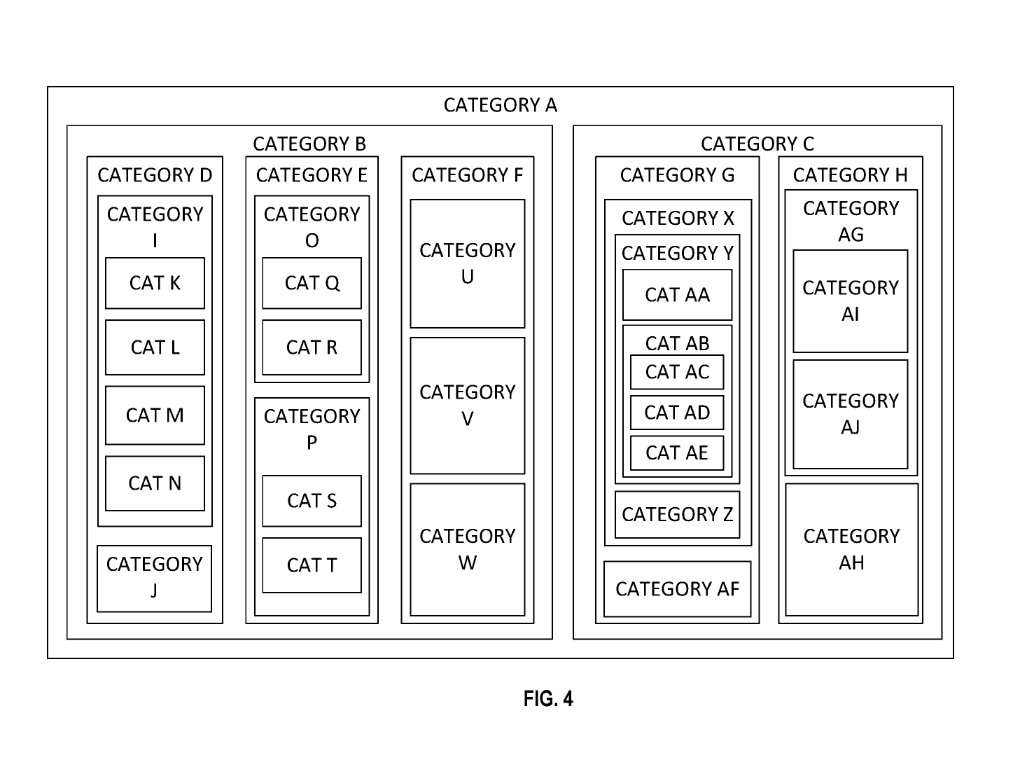

FIG. 4 depicts a diagram of a category hierarchy tree for arranging each product category into a hierarchy in accordance with some example embodiments. In accordance with some example embodiments, a plurality of products are grouped together into product categories. In this example, each category is labeled with a letter (e.g., category A-category AJ). In addition, every product category is organized as part of a hierarchy of categories.

In this example, category A is a general product category that all other product categories descend from. Products in category A are then divided in to at least two different product categories, category B and category C. It should be noted that each parent category (e.g., in this case category A is a parent category to both Category B and Category C) may include a large number of child categories (e.g., subcategories).

In this example, product categories B and C both have subcategories (or child categories). For example, if Category A is clothing, Category B can be Men's clothes and Category C is Women's clothes. Subcategories for Category B include category D, category E, and category F. Each of subcategories D, E, and F have a different number of subcategories, depending on the specific details of the products covered by each subcategory.

For example, if category D is active wear, category E is formal wear, and category F is outdoor wear, each subcategory includes different numbers and types of subcategories. For example, category D (active wear in this example) includes subcategories I and J. Subcategory I includes Active Footwear (for this example) and Subcategory J includes t-shirts. As a result of the differences between these two subcategories, subcategory I includes four additional subcategories (subcategories K-N) to represent different types of active footwear (e.g., running shoes, basketball shoes, climbing shoes, and tennis shoes). In contrast, subcategory J (which, in this example, is for t-shirts) does not include any subcategories (although in a real product database a t-shirt product category would likely include subcategories).

Thus, each category has a parent category (except for the uppermost product category) which represents a more general category of products and one or more child categories or subcategories (which are a more specific product category within the more general category). Thus, category E has two sub-categories, O and P, and each subcategory has two child product categories, categories Q and R and categories S and T, respectively. Similarly, category F has three sub-categories (U, V, and W).

Category C, a product category that has Category A as its parent, includes two additional subcategories (G and H). Category G includes two children (X and AF). Category X includes subcategories Y and Z, and Y includes AA-AE. Category H includes subcategories AG and AH. Category AG includes categories AI and AJ.

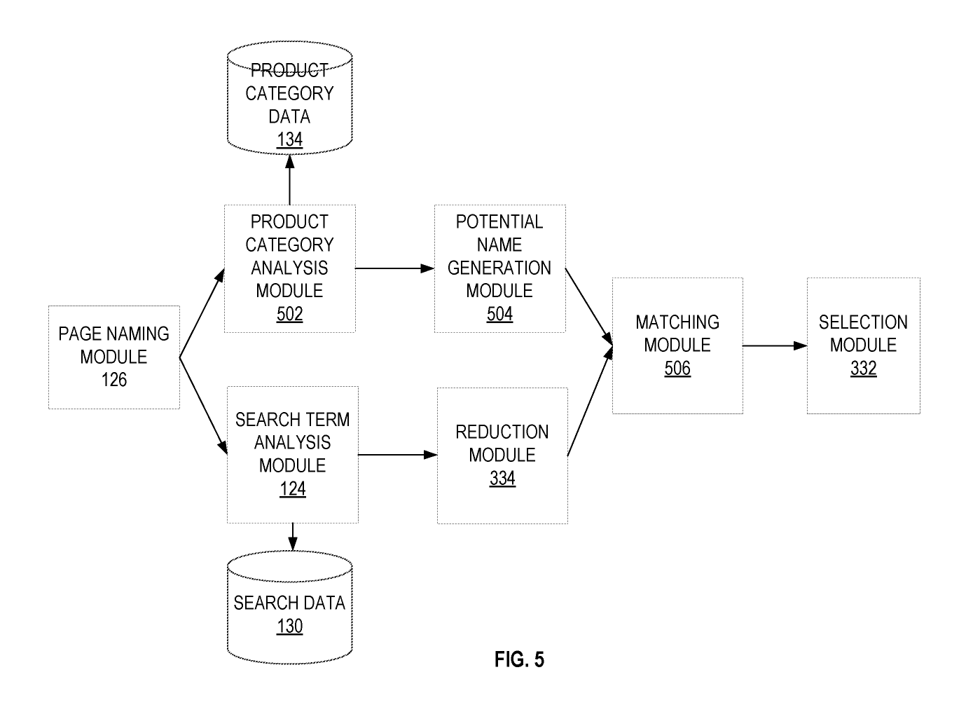

FIG. 5 illustrates a block diagram of a system for generating useful page titles for static pages associated with particular product categories in accordance with some example embodiments. In this example, the page naming module 126 selects a product category that lacks a page name for a static page associated with the product category. In some example embodiments, the page naming module 126 generates a page name for a newly created product category. In other example embodiments, the page naming module 126 receives a request from another portion of the system.

In some example embodiments, the page naming module 126 transmits a product category identifier to the search term analysis module 124. In some example embodiments, the search term analysis module 124 uses the product category identifier for a particular product category to identify a set of search terms associated with the particular product category. The search term analysis module 124 accesses stored search data 130. The search data 130 includes records of submitted search queries, the search results that were sent in response to a search query, and which, if any, of the search results the requesting user clicked on.

In some example embodiments, the search term analysis module 124 determines all search queries that resulted in the user clicking on the static product page for the particular product category. In some example embodiments, the search terms are grouped and the search term analysis module 124 determines what percentage of all clicks on the product page were received from each particular search term. Thus, search term A results in 20 percent of all clicks, search term B results in the next 15 percent, search term C results in the next 10, and so on.

In some example embodiments, the reduction module 334 reduces the total number of search terms included in the set of identified search terms associated with the particular product category. In this way, search terms that very rarely result in clicks on the product page of the product category are not included in the overall set of terms to ensure the set only includes very relevant search terms.

In some example embodiments, the reduction module 334 determines a number of search terms to include. In some example embodiments, the number of search terms is determined by a predetermined measure of search term relevance (e.g., a certain percentage of clicks) and any search term that meets the criteria is included. In other example embodiments, the reduction module 334 determines a percentage of all clicks that will be included. For example, the reduction module 334 includes 80 percent of the clicks. The first search term represents the largest percentage of all clicks (15 percent). Each additional search term is added to the set starting with the highest percentage first. Once the included search terms represent 80 percent of all clicks, the reduction module 334 stops adding additional terms to the set and the remaining search terms (which represent a smaller percentage of all clicks) are left out of the set.

The page naming module 126 also transmits the product category identifier to the product category analysis module 502. The product category analysis module 502 then accesses the product category data 134 to determine the name of the product category identified by the product category identifier. The product category analysis module 502 also identifies the names of all the product categories associated with the identified product category. For example, the product category analysis module 502 identifies the parent of the identified product category, the parent of the parent of the identified product category, and so on. Thus, all the product categories associated with the identified product category are identified all the way up to the uppermost product category.

In some example embodiments, the product category analysis module 502 sends the set of all product category names to the potential name generation module 504. The potential name generation module 504 generates a series of n-grams. Each n-gram represents a combination of all the words (names of product categories) received from the product category analysis module 502. The various n-grams include potential product names that are a single word (1-gram), any combination of two words (2-grams), and so on.

Once the potential name generation module 504 has generated a plurality of potential product page names, the potential names are transmitted to the matching module 506. In some example embodiments, the matching module 506 compares each potential product category page name with the set of search terms generated by the search term analysis module 124. Each potential product page name that matches a search query is then passed to the selection module 332.

If more than one potential product page name is passed to the selection module 332 (e.g., if more than one potential product page name matches a search query), the selection module 332 then ranks each potential product page name based on one or more factors including potential page name length, the popularity of the matching search query, and so on. The selection module 332 then selects the highest ranked search query as the product category webpage name (or title).

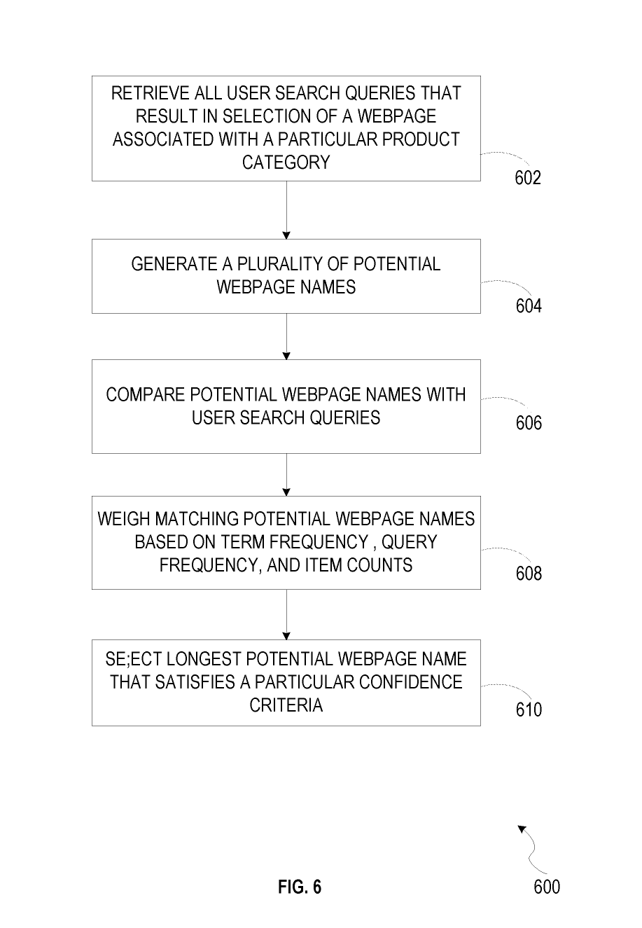

FIG. 6 is a flow diagram illustrating a method 600, in accordance with some example embodiments, for fragmenting catalogue names to simple components that match vocabulary in which users express their intent. Each of the operations shown in FIG. 6 may correspond to instructions stored in a computer memory or computer-readable storage medium. In some embodiments, the method 600 described in FIG. 6 is performed by the server system (e.g., the server system 120 in FIG. 1). However, the method 600 can also be performed by any other suitable configuration of electronic hardware.

In some embodiments the method 600 is performed at a server system (e.g., the server system 120 in FIG. 1) including one or more processors and memory storing one or more programs for execution by the one or more processors.

In some example embodiments, the server system (e.g., the server system 120 in FIG. 1) retrieves (602) all user search queries that result in selection of a webpage associated with a particular product category. For example, each time a user submits a search query to the server system (e.g., the server system 120 in FIG. 1), the server system records the search query and then generates a series of search results. In some example embodiments, the search results are a series of links to webpages that are associated with the search query. The search results are then presented to the user who submitted the search query (e.g., by transmitting the search results to the user's computer via a computer network for display).

The user can then select one or more of the search results. When a user selects a search result in the set of search results (e.g., by clicking on it), the selection is transmitted to the server system (e.g., the server system 120 in FIG. 1). The server system then records the selection and the search query that initiated the search results. Thus, when the server system needs to determine all the search queries that resulted in a user selecting a particular page (e.g., the webpage for a particular product category in this case), the server system accesses the records to determine each time that a user selected the particular page and then records the search query in each case.

In some example embodiments, the server system (e.g., the server system 120 in FIG. 1) then generates (604) a plurality of potential webpage names. In some example embodiments, the server system accesses the category name of the product category for which the name is being generated (e.g., a leaf product category in a hierarchical tree of product categories) and the names of any parent categories. The words in these category names are then arranged in a plurality of different configurations (e.g., different numbers of words and different orders).

In some example embodiments, the server system (e.g., the server system 120 in FIG. 1) compares (606) the potential webpage names to the retrieved user search queries. In some example embodiments, the server system determines, for each potential webpage name, whether there is a search query that is an exact text match in the set of retrieved user search queries.

In some example embodiments, the server system (e.g., the server system 120 in FIG. 1) weighs (608) each matching potential webpage name based on term frequency (e.g., how often the terms in the potential webpage name occur in the search queries and category names), query frequency (e.g., how popular the matching search query was), and item counts. In some example embodiments, the server system generates a score for each matching potential product name.

In some example embodiments, the server system (e.g., the server system 120 in FIG. 1) selects (610) the longest potential webpage name that satisfies a predetermined confidence criteria or threshold. In some example embodiments, the threshold is represented as a particular score.

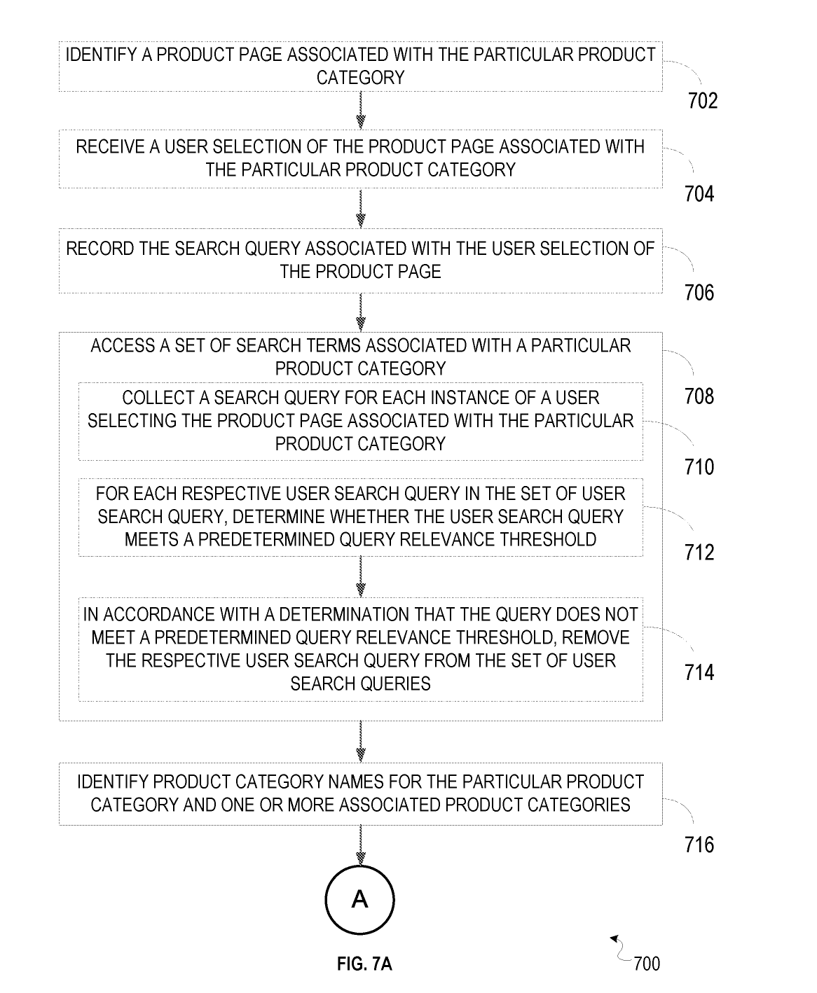

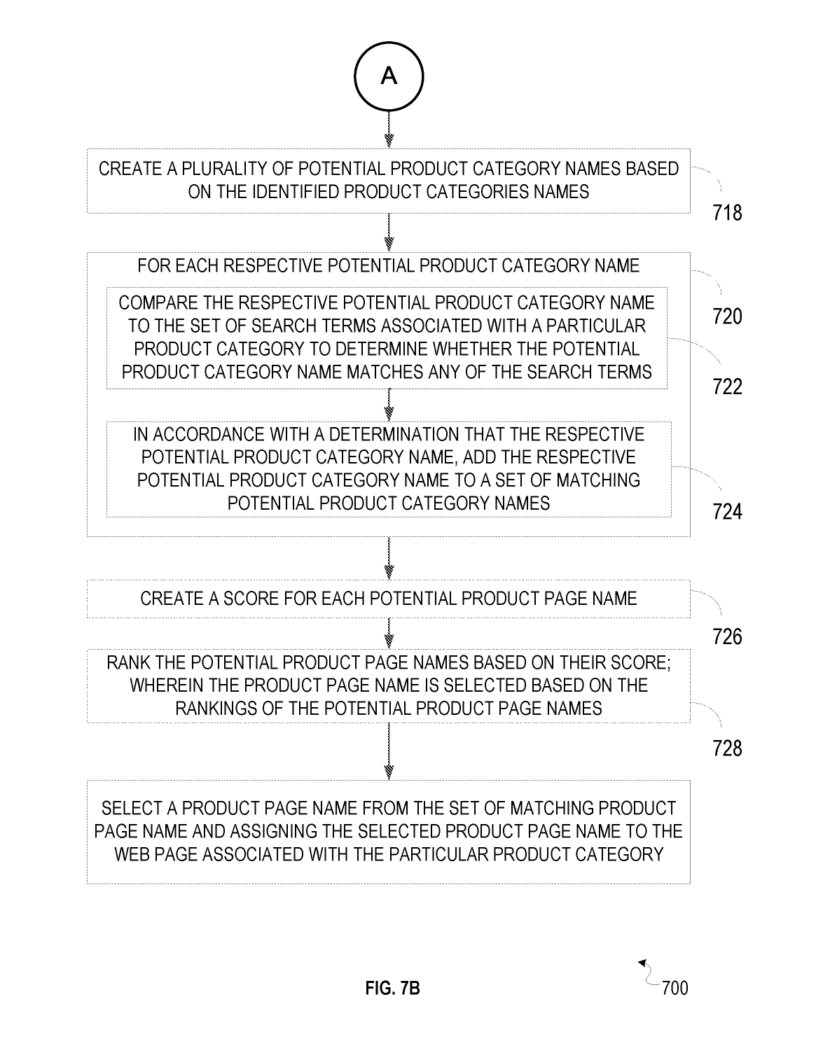

FIG. 7A is a flow diagram illustrating a method 700, in accordance with some example embodiments, for fragmenting catalogue names to simple components that match vocabulary in which users express their intent. Each of the operations shown in FIG. 7A may correspond to instructions stored in a computer memory or computer-readable storage medium. Optional operations are indicated by dashed lines (e.g., boxes with dashed-line borders). In some embodiments, the method 700 described in FIG. 7A is performed by the server system (e.g., the server system 120 in FIG. 1). However, the method 700 can also be performed by any other suitable configuration of electronic hardware.

In some embodiments the method 700 is performed at a server system (e.g., the server system 120 in FIG. 1) including one or more processors and memory storing one or more programs for execution by the one or more processors.

In some example embodiments, the server system (e.g., the server system 120 in FIG. 1) identifies (702) a product page associated with the particular product category. In some example embodiments, the product page is a static product page (e.g., a web page for a product category that is not dynamically generated). A static product page allows users to more easily find information about a particular product category by being easier to index for search. A dynamic product page can more flexibly represent a variety of product categories but is more difficult to index for search because the contents cannot be definitively known beforehand.

In some example embodiments, each product category is defined by data stored in a database and includes a link to the static webpage of the product category.

In some example embodiments, the server system (e.g., the server system 120 in FIG. 1) receives (704) a user selection of the product page associated with the particular product category. For example, a user clicks on a link to a product page that initiates a page request to the server system (e.g., the server system 120 in FIG. 1).

In some example embodiments, the server system (e.g., the server system 120 in FIG. 1) records (706) the search query associated with the user selection of the product page. In some example embodiments, the server system first determines whether the selection of the product page was associated with a search query at all. For example, the web page selection request includes meta-data that informs the server system as to the source of the webpage request. In other example embodiments, the server system stores a set of all search results sent to a particular client system and, if the webpage request is for a webpage included in the search results and the request was received within a predetermined window of time (e.g., less than 30 seconds) the server system determines that the webpage request is associated with the search query that prompted the search results to be sent to the client system.

In accordance with a determination that the webpage request is associated with a particular web query, that web query is then stored in a set of web queries that are associated with the product page.

In some example embodiments, the server system (e.g., the server system 120 in FIG. 1) accesses (708) a set of search terms associated with a particular product category. For example, the server system stores a database of past search queries and the resulting user selections. The server system can identify all search queries that resulted in the selection of the product page associated with the particular product category.

In some example embodiments, the server system (e.g., the server system 120 in FIG. 1) collects (710) a search query for each instance of a user selecting the product page associated with the particular product category.

In some example embodiments, for each user search query in the set of user search queries, the server system (e.g., the server system 120 in FIG. 1) determines (712) whether the user search query meets a predetermined query relevance threshold. In some example embodiments, the predetermined query relevance threshold is based on the total percentage of clicks that come from the respective user search query. For example, search query A results in 10 percent of all visits to the product category webpage and search query B results in 0.6 percent of all visits to the product category webpage. If the predetermined relevance criteria is 1.5 percent, search query A would be deemed to meet the relevance criteria and search query B would not.

In other example embodiments, the search query relevance criteria is based on the likelihood that the user will then select the particular product category webpage. For example, a user that submits a very popular search query (e.g., shoes) has a 5 percent chance of ultimately clicking on the “Men's dress shoes” page. In contrast, a user that searches “Asos shoes” will have an 80 percent change of clicking on the “Men's dress shoes” page. Thus, if the criteria is based on whether 20 percent of users who submit a search query click on the particular category of webpage after entering a particular search query, “Asos shoes” will meet the criteria while the more common “shoes” will not.

In some example embodiments, the server system (e.g., the server system 120 in FIG. 1) determines a particular percent of all user clicks that will be included in the set. For example, the server system predetermined that search queries representing 70 percent of all clicks are to be included in the set of search queries. In this example, the server system arranges search queries from highest percentage of total clicks to lowest. Then the server system adds search queries to the set, starting with the highest total percentage, until the total percentage represented by all search queries on the set represents at least 70 percent. The rest of the search queries are determined to not meet relevance criteria and are left off the set of search queries.

In accordance with a determination that the query does not meet a predetermined query relevance threshold, the server system (e.g., the server system 120 in FIG. 1) removes (714) the respective user search query from the set of user search queries.

In some example embodiments, the server system (e.g., the server system 120 in FIG. 1) identifies (716) product category names for the particular product category and one or more associated product categories. In some example embodiments, the product categories are arranged in a hierarchical tree. In some example embodiments, the one or more associated categories are parent categories of the particular product category in the hierarchical tree.

For example, if the particular product category is “black leather men's shoes,” its parent categories include “men's leather shoes”, “men's formal shoes,” “men's shoes,” “shoes,” and “apparel,” each of which is one step in a hierarchal tree. All these names are then included in the listed of product category names for the particular product category.

FIG. 7B is a flow diagram further illustrating the method 700, in accordance with some example embodiments, for fragmenting catalogue names to simple components that match vocabulary in which users express their intent. Each of the operations shown in FIG. 7B may correspond to instructions stored in a computer memory or computer-readable storage medium. Optional operations are indicated by dashed lines (e.g., boxes with dashed-line borders). In some embodiments, the method 700 described in FIG. 7B is performed by the server system (e.g., the server system 120 in FIG. 1). However, the method 700 described can also be performed by any other suitable configuration of electronic hardware.

In some embodiments the method 700 is performed at a server system (e.g., the server system 120 in FIG. 1) including one or more processors and memory storing one or more programs for execution by the one or more processors.

In some example embodiments, the server system (e.g., the server system 120 in FIG. 1) creates (718) a plurality of potential product category names based on the identified product categories names. In some example embodiments, potential product category names include a variable number of words. For example, some of the potential product category names have one word, some have two words, some have three words, and so on.

In some example embodiments, each potential product category name includes a different variation of the words included in the product category names for the particular product category and one or more associated product categories. In some example embodiments, the server system (e.g., the server system 120 in FIG. 1) generates all combinations of words possible from the set of names of the particular product category and related product categories.

In some example embodiments, for each respective potential product category name (720), the server system (e.g., the server system 120 in FIG. 1) compares (722) the respective potential product category name to the set of search terms associated with a particular product category to determine whether the potential product category name matches any of the search terms. For example, each potential product category name is compared with all search terms to determine whether it is an exact text match.

In accordance with a determination that the respective potential product category name matches any of the search terms, the server system (e.g., the server system 120 in FIG. 1) adds (724) the respective potential product category name to a set of matching potential product category names.

In some example embodiments, the server system (e.g., the server system 120 in FIG. 1) creates (726) a score for each potential product page name. In some example embodiments, potential product names are scored based on length of the name, the popularity of the matching user search query, and the popularity/frequency of the words in the potential product page name and so on.

In some example embodiments, the server system (e.g., the server system 120 in FIG. 1) ranks (728) the potential product page names based on their score; wherein the product page name is selected based on the rankings of the potential product page names.

In some example embodiments, the server system (e.g., the server system 120 in FIG. 1) selects (730) a product page name from the set of matching product page names and assigns the selected product page name to the webpage associated with the particular product category. In some example embodiments, the selected product page name is then added to the static product category page and used to index that page.

In some example embodiments, potential product page names are ranked based on the length of the potential product page names, the popularity of the search terms that match the potential product page names, and the popularity of words that make up each potential product page name.

In some example embodiments, the server system (e.g., the server system 120 in FIG. 1) analyzes the selected product page name for all product categories. If two categories have the same product category name, the server system flags those categories for review to determine whether they should be combined into a single product category.

Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

Machine and Software Architecture

The modules, methods, applications and so forth described in conjunction with FIGS. 1-7 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

Software Architecture

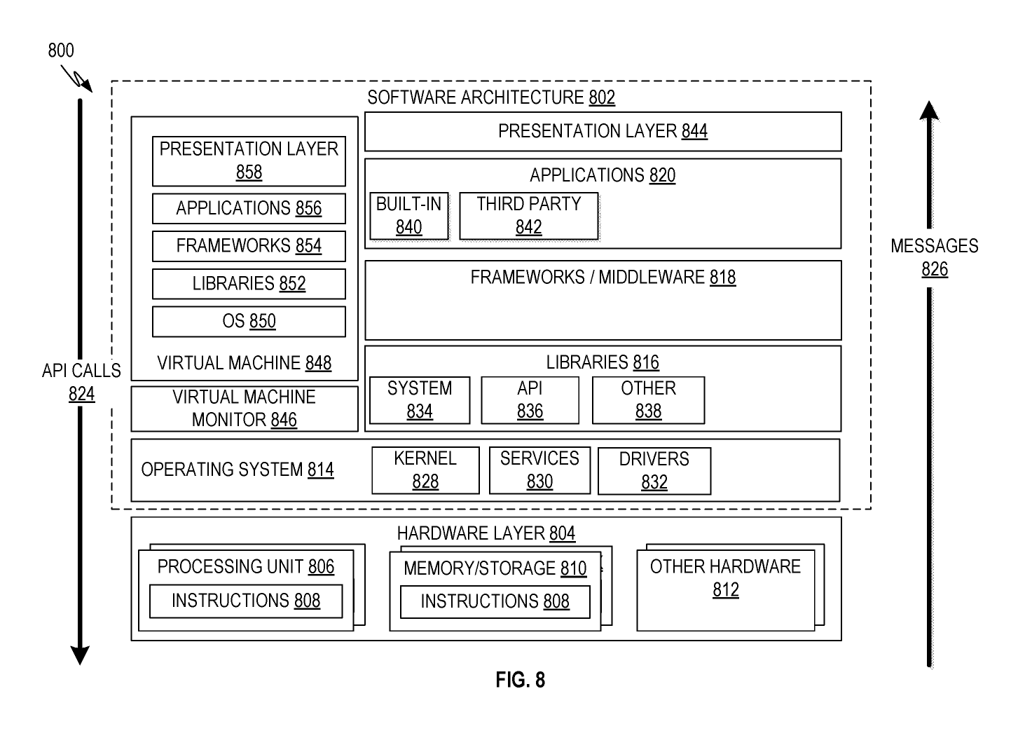

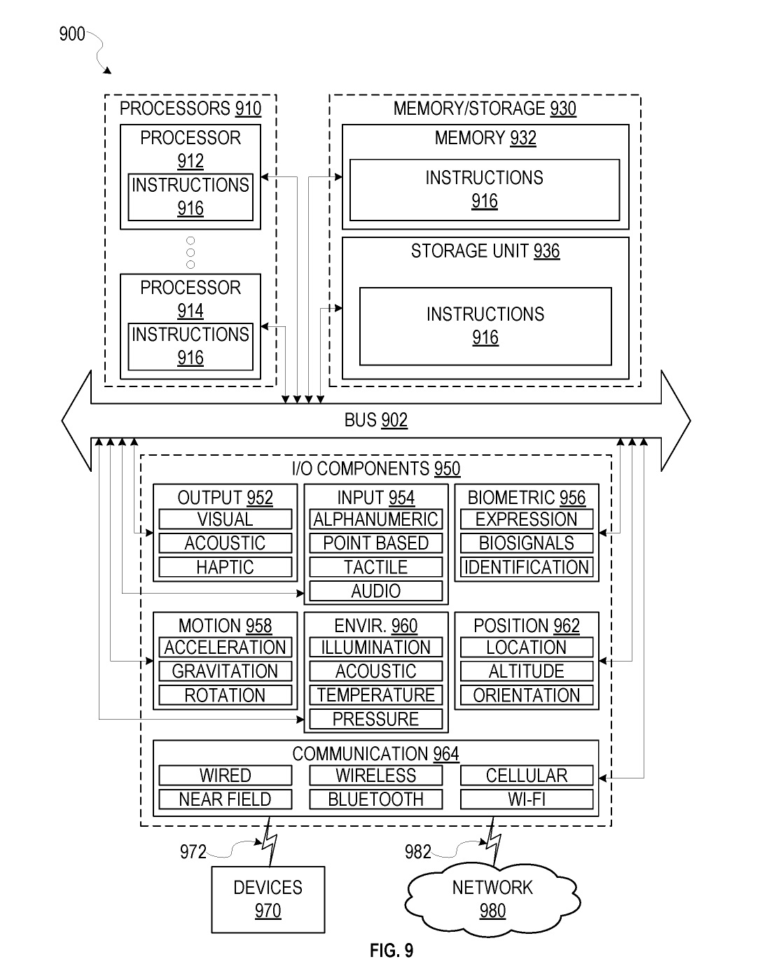

FIG. 8 is a block diagram 800 illustrating a representative software architecture 802, which may be used in conjunction with various hardware architectures herein described. FIG. 8 is merely a non-limiting example of a software architecture 802 and it will be appreciated that many other architectures may be implemented to facilitate the functionality described herein. The software architecture 802 may be executing on hardware such as a machine 900 of FIG. 9 that includes, among other things, processors 910, memory/storage 930, and I/O components 950. A representative hardware layer 804 is illustrated in FIG. 8 and can represent, for example, the machine 900 of FIG. 9. The representative hardware layer 804 comprises one or more processing units 806 having associated executable instructions 808. The executable instructions 808 represent the executable instructions of the software architecture 802, including implementation of the methods, modules, and so forth of FIGS. 1-7. The hardware layer 804 also includes memory and/or storage modules 810, which also have the executable instructions 808. The hardware layer 804 may also comprise other hardware 812, which represents any other hardware of the hardware layer 804, such as the other hardware illustrated as part of the machine 900.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and a presentation layer 844. Operationally, the applications 820 and/or other components within the layers may invoke application programming interface (API) calls 824 through the software stack and receive a response, returned values, and so forth, illustrated as messages 826, in response to the API calls 824. The layers illustrated are representative in nature and not all software architectures have all layers. For example, some mobile or special purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 or other components or layers. The libraries 816 typically provide functionality that allows other software modules to perform tasks in an easier fashion than to interface directly with the underlying operating system 814 functionality (e.g., kernel 828, services 830, and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware 818 may provide a higher-level common infrastructure that may be utilized by the applications 820 or other software components/modules. For example, the frameworks/middleware 818 may provide various graphic user interface (GUI) functions, high-level resource management, high-level location services, and so forth. The frameworks/middleware 818 may provide a broad spectrum of other APIs that may be utilized by the applications 820 or other software components/modules, some of which may be specific to a particular operating system or platform.

The applications 820 include built-in applications 840 or third party applications 842. Examples of representative built-in applications 840 may include, but are not limited to, a contacts application, a browser application, a book reader application, a location application, a media application, a messaging application, or a game application. The third party applications 842 may include any of the built in applications 840 as well as a broad assortment of other applications. In a specific example, the third party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 842 may invoke the API calls 824 provided by the mobile operating system such as the operating system 814 to facilitate functionality described herein.

The applications 820 may utilize built-in operating system functions (e.g., kernel 828, services 830, and/or drivers 832), libraries (e.g., system libraries 834, API libraries 836, and other libraries 838), and frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with a user.

Some software architectures utilize virtual machines. In the example of FIG. 8, this is illustrated by a virtual machine 848. A virtual machine creates a software environment where applications/modules can execute as if they were executing on a hardware machine (e.g., the machine 900 of FIG. 9). A virtual machine is hosted by a host operating system (e.g., operating system 814) and typically, although not always, has a virtual machine monitor 846, which manages the operation of the virtual machine 848 as well as the interface with the host operating system (e.g., operating system 814). A software architecture executes within the virtual machine 848 such as an operating system 850, libraries 852, frameworks 854, applications 856, or presentation layer 858. These layers of software architecture executing within the virtual machine 848 can be the same as corresponding layers previously described or may be different.

Example Machine Architecture and Machine-readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the flow diagrams of FIGS. 5-7. The instructions 916 transform the general, non-programmed machine 900 into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory/storage 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 912 and a processor 914 that may execute the instructions 916. The term “processor” is intended to include a multi-core processor that may comprise two or more independent processors (sometimes referred to as “cores”) that may execute the instructions 916 contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and the memory 932 store the instructions 916 embodying any one or more of the methodologies or functions described herein. The instructions 916 may also reside, completely or partially, within at least one of the processors 910 (e.g., within the processor's cache memory), or any suitable combination thereof, during execution thereof by the machine 900. Accordingly, the memory 932, the storage unit 936, and the memory of the processors 910 are examples of machine-readable media.

As used herein, “machine-readable medium” means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972 respectively. For example, the communication components 964 may include a network interface component or other suitable device to interface with the network 980. In further examples, the communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geo-location, location via Wi-Fi® signal triangulation, location via detecting an NFC beacon signal that may indicate a particular location, and so forth.

Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine 900, and includes digital or analog communications signals or other intangible media to facilitate communication of such software.

Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
accessing a set of search terms associated with a particular product category;
identifying product category names for the particular product category and one or more associated product categories;
creating a plurality of potential product category names based on the identified product category names;
for each respective potential product category name:
comparing the respective potential product category name to the set of search terms associated with the particular product category to determine whether the potential product category name matches any of the search terms; and
in accordance with a determination that the respective potential product category name matches any of the search terms, adding the respective potential product category name to a set of matching potential product category names; and
selecting a product page name from the set of matching potential product category names and assigning the selected product page name to a webpage associated with the particular product category.

2. The method of claim 1, further comprising:
identifying a product page associated with the particular product category;
receiving a user selection of the product page associated with the particular product category; and
recording a search query associated with the user selection of the product page.

3. The method of claim 2, wherein accessing the set of search terms associated with the particular product category further includes:
collecting a search query for each instance of a user selecting the product page associated with the particular product category.

4. The method of claim 1, wherein product categories are arranged in a hierarchical tree.

5. The method of claim 4, wherein the one or more associated product categories are parent categories of the particular product category in the hierarchical tree.

6. The method of claim 1, wherein each potential product category name of the product category names includes a variable number of words.

7. The method of claim 6, wherein each potential product category name includes a different variation of the words included in the product category names for the particular product category and one or more associated product categories.

8. The method of claim 1, further comprising:
creating a score for each potential product page name; and
ranking the potential product page names based on their score, wherein the product page name is selected based on the rankings of the potential product page names.

9. The method of claim 8, wherein potential product page names are ranked based in on the length of the potential product page names, the popularity of search terms that match the potential product page name, and the popularity of words that make up each potential product page name.

10. The method of claim 2, further comprising:
for each search query associated with the user selection of the product page, determining whether the search query meets a predetermined query relevance threshold; and
in accordance with a determination that the search query does not meet a predetermined query relevance threshold, removing the respective search query from the set of search terms.

11. A system comprising:
one or more processors;
memory; and
one or more programs stored in the memory, the one or more programs comprising instructions for:
accessing a set of search terms associated with a particular product category;
identifying product category names for the particular product category and one or more associated product categories;
creating a plurality of potential product category names based on the identified product category names;
for each respective potential product category name:
comparing the respective potential product category name to the set of search terms associated with the particular product category to determine whether the potential product category name matches any of the search terms; and
in accordance with a determination that the respective potential product category name matches any of the search terms, adding the respective potential product category name to a set of matching potential product category names; and
selecting a product page name from the set of matching potential product category names and assigning the selected product page name to a webpage associated with the particular product category.

12. The system of claim 11, further comprising:
identifying a product page associated with the particular product category;
receiving a user selection of the product page associated with the particular product category; and
recording a search query associated with the user selection of the product page.

13. The system of claim 12, wherein accessing the set of search terms associated with the particular product category further includes:
collecting a search query for each instance of a user selecting the product page associated with the particular product category.

14. The system of claim 11, wherein product categories are arranged in a hierarchical tree.

15. The system of claim 14, wherein the one or more associated product categories are parent categories of the particular product category in the hierarchical tree.

16. A non-transitory computer-readable storage medium storing instructions that, when executed by the one or more processors of a machine, cause the machine to perform operations comprising:
accessing a set of search terms associated with a particular product category;
identifying product category names for the particular product category and one or more associated product categories;
creating a plurality of potential product category names based on the identified product category names;
for each respective potential product category name:
comparing the respective potential product category name to the set of search terms associated with the particular product category to determine whether the potential product category name matches any of the search terms; and
in accordance with a determination that the respective potential product category name matches any of the search terms, adding the respective potential product category name to a set of matching potential product category names; and
selecting a product page name from the set of matching potential product category names and assigning the selected product page name to a webpage associated with the particular product category.

17. The non-transitory computer-readable storage medium of claim 16, further comprising:
identifying a product page associated with the particular product category;
receiving a user selection of the product page associated with the particular product category; and
recording a search query associated with the user selection of the product page.

18. The non-transitory computer-readable storage medium of claim 17, wherein accessing the set of search terms associated with the particular product category further includes:
collecting a search query for each instance of a user selecting the product page associated with the particular product category.

19. The non-transitory computer-readable storage medium of claim 1, wherein product categories are arranged in a hierarchical tree.

20. The non-transitory computer-readable storage medium of claim 19, wherein the one or more associated product categories are parent categories of the particular product category in the hierarchical tree.
